(19) United States
(12) Patent Application Publication
(10) Pub. No.: US 2013/0092868 A1
(43) Pub. Date: Apr. 18, 2013

(54) R-T-B-BASED RARE EARTH PERMANENT MAGNET, MOTOR, AUTOMOBILE, POWER GENERATOR, AND WIND POWER-GENERATING APPARATUS

(71) Applicants: Kenichiro Nakajima, Chichibu-shi (JP); Takashi Yamazaki, Chichibu-shi (JP)

(72) Inventors: Kenichiro Nakajima, Chichibu-shi (JP); Takashi Yamazaki, Chichibu-shi (JP)

(73) Assignee: SHOWA DENKO K.K., Minato-ku, Tokyo (JP)

(21) Appl. No.: 13/807,252

(22) PCT Filed: May 19, 2011
(86) PCT No.: PCT/JP2011/061541

§ 371 Date: Dec. 27, 2012

(30) Foreign Application Priority Data
Jun. 29, 2010 (JP) 2010-147621

(51) Int. Cl. H01F 1/01

(52) U.S. Cl. CPC H01F 1/01
USPC 252/62.51 R

(57) ABSTRACT

An R-T-B-based rare earth permanent magnet including a sintered compact having a main phase mainly including R₂Fe₁₄B and grain boundary phases including more R than the main phase, in which R refers to rare earth elements including Nd as an essential element, the sintered compact includes Ga as an essential elements, the grain boundary phases include a first grain boundary phase, a second grain boundary phase, and a third grain boundary phase which have different total atomic concentrations of the rare earth elements, and the third grain boundary phase has a lower total atomic concentration of the rare earth elements than the first grain boundary phase and the second grain boundary phase, and has a higher atomic concentration of Fe than the first grain boundary phase and the second grain boundary phase.

### TECHNICAL FIELD

The present invention relates to an R-T-B-based rare earth permanent magnet, a motor, an automobile, a power generator, and a wind power-generating apparatus, and particularly to an R-T-B-based rare earth permanent magent which has excellent magnetic characteristics and is preferably used in a motor or a power generator, and a motor, an automobile, a power generator, and a wind power-generating apparatus which use the same.

Priority is claimed on Japanese Patent Application No. 2010-147621, filed Jun. 29, 2010, the content of which is incorporated herein by reference.

### BACKGROUND ART

R-T-B-based rare earth permanent magnets have thus far been used in a variety of motors, power generators, and the like. In recent years, due to an increasing demand for energy saving as well as an improvement in heat resistance of R-T-B-based rare earth permanent magnets, the proportion of R-T-B-based rare earth permanent magnets used in motors including automobiles has been increasing.

An R-T-B-based rare earth permanent magnet mainly includes Nd, Fe, and B. In an R-T-B-based magnet alloy R refers to elements obtained by substituting some of Nd with other rare earth elements such as Pr, Dy, or Tb. T refers to elements obtained by substituting some of Fe with other transition metals such as Co or Ni. B refers to boron.

As a material used for R-T-B-based rare earth permanent magnets, a material in which the volume fraction of a R₂Fe₁₄B phase (here, R represents at least one rare earth element), which is a main phase component, is 87.5% to 97.5%, in an R—Fe—B-based magnet alloy including a rare earth element or an oxide of a rare earth element and a transition metal at a volume fraction of 0.1% to 3%, as primary components in the metallic structure of the alloy, compounds selected from a ZrB compound consisting of Zr and B, an NbB compound consisting of Nb and B, and a HfB compound consisting of Hf and B have an average particle diameter of 5 μm or less, and the compounds selected from the ZrB compound, the NbB compound, and the HfB compound, which are adjacently present in the alloy, are uniformly dispersed at maximum intervals of 50 μm or less is proposed (for example, refer to PTL 1).

In addition, as a material used for R-T-B-based permanent magnets, a material in which, in an R—Fe—Co—B—Al—Cu (here, R represents one or two or more of Nd, Pr, Dy, Tb, and Ho, and contains 15 mass % to 33 mass % of Nd)-based rare earth permanent magnet material, at least two of M-B-based compounds, M-B—Cu-based compounds, and M-C-based compounds (M represents one or two or more of Ti, Zr, and Hf), and, furthermore, an R oxide precipitate in the alloy structure is proposed (for example, refer to PTL 2).

### CITATION LIST

### Patent Literature

[PTL 1] Japanese Patent No. 3951099

[PTL 2] Japanese Patent No. 3891307

### SUMMARY OF INVENTION

### Technical Problem

However, in recent years, there has been a demand for an R-T-B-based rare earth permanent magnet having higher performances, and there has been a demand for a further improvement in the magnetic characteristics such as coercivity of the R-T-B-based rare earth permanent magnet. Particularly, in motors, there is a problem in that rotation generates an electric current inside a motor, the motor generates heat so as to reach a high temperature, the magnetic force decreases, and the efficiency decreases. In order to overcome the above problem, there is a demand for a rare earth permanent magnet having a high coercivity at room temperature.

As a method of improving coercivity of an R-T-B-based rare earth permanent magnet, a method of increasing the concentration of Dy in the R-T-B-based alloy can be considered. As the concentration of Dy in the R-T-B-based alloy increases, a rare earth permanent magnet having a higher coercive force (Hcj) can be obtained after sintering. However, when the concentration of Dy in the R-T-B-based alloy is high, remanence (Br) is degraded.

Therefore, in the related art, it was difficult to sufficiently enhance the magnetic properties such as coercivity of R-T-B-based rare earth permanent magnets.

The invention has been made in consideration of the above circumstances, and an object of the invention is to provide an R-T-B-based rare earth permanent magnet in which a high coercivity (Hcj) can be obtained without increasing the concentration of Dy in an R-T-B-based alloy so that excellent magnetic properties can be obtained.

In addition, another object of the invention is to provide a motor, an automobile, a power generator, and a wind power-generating apparatus which use the R-T-B-based rare earth permanent magnet having excellent magnetic properties.

### Solution to Problem

The present inventors have investigated the relationships among structures included in R-T-B-based rare earth permanent magnets, the compositions of grain boundary phases, and the magnetic properties of the R-T-B-based rare earth permanent magnets. As a result, it has been found that the grain boundary phases including more R than the main phase include a first grain boundary phase, a second grain boundary phase, and a third grain boundary phase which have different total atomic concentrations of the rare earth elements, in a case in which the third grain boundary phase has a lower total atomic concentration of the rare earth elements than the first grain boundary phase and the second grain boundary phase, and has a higher atomic concentration of Fe than the first grain boundary phase and the second grain boundary phase, compared to an R-T-B-based rare earth permanent magnet including two or less kinds of grain boundary phases, a sufficiently high coercive (Hcj) can be obtained without increasing the concentration of Dy so that the magnetic properties of the R-T-B-based rare earth permanent magnet are effectively improved, and the invention was achieved.

The above effect is assumed to result from the fact that the grain boundary phases included in the R-T-B-based rare earth permanent magnet include the third grain boundary phase having a lower concentration of the rare earth elements than the first grain boundary phase and the second grain boundary phase, and having a higher atomic concentration of Fe than the first grain boundary phase and the second grain boundary phase.

That is, the invention provides the following.

(1) An R-T-B-based rare earth permanent magnet consisting of a sintered compact having a main phase mainly including R₂Fe₁₄B and grain boundary phases including more R than the main phase, in which R refers to rare earth elements including Nd as an essential element, the sintered compact includes Ga as an essential element, the grain boundary phases include a first grain boundary phase, a second grain boundary phase, and a third grain boundary phase which have different total atomic concentrations of the rare earth elements, and the third grain boundary phase has a lower total atomic concentration of the rare earth elements than the first grain boundary phase and the second grain boundary phase, and has a higher atomic concentration of Fe than the first grain boundary phase and the second grain boundary phase.

(2) The R-T-B-based rare earth permanent magnet according to the above (1), in which the atomic concentration of Fe in the third grain boundary phase is 50 at % to 70 at %.

(3) The R-T-B-based rare earth permanent magnet according to the above (1) or (2), in which the volume proportion of the third grain boundary phase in the sintered compact is 0.005% to 0.25%.

(4) The R-T-B-based rare earth permanent magnet according to any one of the above (1) to (3), in which the atomic concentration of Ga in the third grain boundary phase is higher than the atomic concentrations of Ga in the first grain boundary phase and the second grain boundary phase.

(5) The R-T-B-based rare earth permanent magnet according to any one of the above (1) to (4), in which the atomic concentration of Fe in the first grain boundary phase is higher than the atomic concentration of Fe in the second grain boundary phase.

(6) The R-T-B-based rare earth permanent magnet according to the above (5), in which the total atomic concentration of the rare earth elements in the first grain boundary phase is higher than the total atomic concentration of the rare earth elements in the second grain boundary phase.

(7) The R-T-B-based rare earth permanent magnet according to the above (5) or (6), in which the atomic concentration of oxygen in the second grain boundary phase is higher than the atomic concentration of oxygen in the main phase, the first grain boundary phase or the third grain boundary phase.

(8) A motor having the R-T-B-based rare earth permanent magnet according to any one of the above (1) to (7).

(9) An automobile having the motor according to the above (8).

(10) A power generator having the R-T-B-based rare earth permanent magnet according to any one of the above (1) to (7).

(11) A wind power-generating apparatus having the power generator according to the above (10).

### Advantageous Effects of Invention

Since the R-T-B-based rare earth permanent magnet of the invention consists of a sintered compact including Ga which has a main phase mainly including R₂Fe₁₄B (here R represents rare earth elements including Nd as an essential element) and grain boundary phases including more R than the main phase, the grain boundary phases include the first grain boundary phase, the second grain boundary phase, and the third grain boundary phase which have different total atomic concentrations of the rare earth elements, the third grain boundary phase has a lower total atomic concentration of the rare earth elements than the first grain boundary phase and the second grain boundary phase, and has a higher atomic concentration of Fe than the first grain boundary phase and the second grain boundary phase, a high coercivity (Hcj) can be obtained.

In addition, in the R-T-B-based rare earth permanent magnet of the invention, since a sufficiently high coercivity (Hcj) can be obtained without increasing the concentration of Dy, it is possible to suppress degradation of the magnetic properties such as remanence (Br) due to addition of Dy.

As a result, the R-T-B-based rare earth permanent magnet of the invention has excellent magnetic characteristics which can be preferably used for motors or power generators.

### BRIEF DESCRIPTION OF DRAWINGS

FIG. 1 is a microscope photograph of an example of the R-T-B-based rare earth permanent magnet of the invention which is a microscope photograph of an R-T-B-based rare earth permanent magnet of Experimental example 3.

### DESCRIPTION OF EMBODIMENTS

Hereinafter, an embodiment of the invention will be described in detail. In the R-T-B-based rare earth permanent magnet of the invention (hereinafter as abbreviated to the “R-T-B-based magnet”), R refers to rare earth elements including Nd as an essential element, T refers to metals including Fe as an essential element, and B refers to boron. R preferably includes Dy in order to produce the R-T-B-based magnet having a superior coercivity (Hcj).

The R-T-B-based magnet of the invention consists of a sintered compact having a main phase mainly including R₂Fe₁₄B and grain boundary phases including more R than the main phase. Here, the sintered compact includes Ga as an essential element.

The grain boundary phases that configure the R-T-B-based magnet of the invention include a first grain boundary phase, a second grain boundary phase, and a third grain boundary phase which have different total atomic concentrations of rare earth elements.

The third grain boundary phase has a lower total atomic concentration of the rare earth elements than the first grain boundary phase and the second grain boundary phase, and has a higher atomic concentration of Fe than the first grain boundary phase and the second grain boundary phase. Therefore, the third grain boundary phase has a composition that is more similar to the main phase than the first grain boundary phase and the second grain boundary phase.

The effect of improving coercivity (Hcj) which is obtained in the R-T-B-based magnet of the invention is assumed to result from the formation of the third grain boundary phase including a high concentration of Fe in the grain boundary phases.

The atomic concentration of Fe in the third grain boundary phase is preferably 50 at % to 70 at %. When the atomic concentration of Fe in the third grain boundary phase is within the above range, the effect of inclusion of the third grain boundary phase in the grain boundary phases can be more effectively obtained. In contrast to this, when the atomic concentration of Fe in the third grain boundary phase is less than the above range, there is a concern that the effect of including the third grain boundary phase in the grain boundary phases for improving coercivity (Hcj) may become insufficient. In addition, when the atomic concentration of Fe in the third grain boundary phase exceeds the above range, there is a concern that a R₂T₁₇ phase or Fe may precipitate such that the magnetic characteristics are adversely influenced.

In addition, the volume proportion of the third grain boundary phase in the sintered compact is preferably 0.005% to 0.25%. When the volume proportion of the third grain boundary phase is within the above range, the effect of inclusion of the third grain boundary phase in the grain boundary phases can be more effectively obtained. In contrast to this, when the volume proportion of the third grain boundary phase is less than the above range, there is a concern that the effect of improving coercivity (Hcj) may become insufficient. In addition, when the volume proportion of the third grain boundary phase exceeds the above range, there is a concern that a R₂T₁₇ phase or Fe may precipitate such that the magnetic characteristics are adversely influenced, which is not preferable.

In addition, the atomic concentration of Ga in the third grain boundary phase in the sintered compact is higher than the atomic concentrations of Ga in the first grain boundary phase and the second grain boundary phase. The R-T-B-based magnet of the embodiment consists of a sintered compact including Ga which is obtained by pressing, sintering, and thermally treating a raw material including a permanent magnet alloy material including Ga. The third grain boundary phase having a higher atomic concentration of Ga than the first grain boundary phase and the second grain boundary phase can be easily manufactured by pressing, sintering, and thermally treating the raw material including a permanent magnet alloy material including Ga. The reason is assumed to be because Ga included in the permanent magnet alloy material accelerates generation of the third grain boundary phase.

In addition, in the embodiment, the atomic concentration of Fe preferably increases in the order of the second grain boundary phase<the first grain boundary phase<the third grain boundary phase. In the above R-T-B-based magnet, since the grain boundary components favorably encircle main phase particles, the main phase particles are magnetically isolated so that a high coercivity can develop.

In addition, the composition of the R-T-B-based magnet of the invention includes 27 mass % to 33 mass %, preferably 30 mass % to 32 mass %, of R and 0.85 mass % to 1.3 mass %, preferably 0.87 mass % to 0.98 mass %, of B with the remainder being preferably T and inevitable impurities.

When R that configures the R-T-B-based magnet is less than 27 mass %, there are cases in which coercivity becomes insufficient, and when R exceeds 33 mass %, there is a concern that remanence may become insufficient.

In addition, R in the R-T-B-based magnet preferably mainly includes Nd. In addition to Nd, Dy, Sc, Y, La, Ce, Pr, Pm, Sm, Eu, Gd, Tb, Ho, Er, Tm, Yb, or Lu can be included as the rare earth elements included in R of the R-T-B-based magnet, and, among the above, Dy is preferably used.

In a case in which the R-T-B-based magnet includes Dy, the atomic concentration of Dy is preferably 2 mass % to 17 mass %, more preferably 2 mass % to 15 mass %, and still more preferably 4 mass % to 9.5 mass %. When the atomic concentration of Dy in the R-T-B-based magnet exceeds 17 mass %, remanence (Br) is significantly degraded. In addition, when the atomic concentration of Dy in the R-T-B-based magnet is less than 2 mass %, there are cases in which coercivity of the R-T-B-based magnet becomes insufficient for use in motors.

T included in the R-T-B-based magnet is metals including Fe as an essential element, and it is possible to make T include transition metals other than Fe such as Co or Ni. In a case in which T includes Co in addition to Fe, it is possible to improve Tc (Curie temperature), which is preferable.

In addition, B included in the R-T-B-based magnet is preferably included at 0.85 mass % to 1.3 mass %. When there is less than 0.85 mass % of B that configures the R-T-B-based magnet, there are cases in which coercivity becomes insufficient, and when there is more than 1.3 mass % of B, there is a concern that remanence is significantly degraded.

B included in the R-T-B-based magnet is boron, but some of B can be substituted by C or N.

In addition, the R-T-B-based magnet includes Ba in order to improve coercivity. Ga is preferably included at 0.03 mass % to 0.3 mass %. In a case in which 0.03 mass % or more of Ga is included, generation of the third grain boundary phase is accelerated so that it is possible to effectively improve coercivity.

However, when the content of Ga exceeds 0.3 mass %, remanence is degraded, which is not preferable.

In addition, the R-T-B-based magnet preferably includes Al and Cu in order to improve coercivity. Al is preferably included at 0.01 mass % to 0.5 mass %. In a case in which 0.01 mass % or more of Al is included, it is possible to effectively improve coercivity. However, when the content of Al exceeds 0.5 mass %, remanence is degraded, which is not preferable.

Furthermore, the concentration of oxygen in the R-T-B-based magnet is preferably lower so that the concentration is preferably 0.5 mass % or less and more preferably 0.2 mass % or less. In a case in which the content of oxygen is 0.5 mass % or less, it is possible to achieve sufficient magnetic remanence for use in motors. In a case in which the content of oxygen exceeds 0.5 mass %, there is a concern that the magnetic properties may be significantly degraded.

In addition, the concentration of carbon in the R-T-B-based magnet is preferably lower so that the concentration is preferably 0.5 mass % or less and more preferably 0.2 mass % or less. In a case in which the content of carbon is 0.5 mass % or less, it is possible to achieve sufficient magnetic remanence for use in motors. In a case in which the content of carbon exceeds 0.5 mass %, there is a concern that the magnetic properties may be significantly degraded.

Next, a method of manufacturing the R-T-B-based magnet of the invention will be described. In order to manufacture the R-T-B-based magnet of the invention, a method in which a raw material having a permanent magnet alloy material including Ga is molded, sintered, and thermally treated or the like can be employed.

The permanent magnet alloy material including Ga which is used when the R-T-B-based magnet of the invention is manufactured has a composition corresponding to the composition of the R-T-B-based magnet, and a material including an R-T-B-based alloy including Ga and metal powder is preferably used.

In a case in which a material including the R-T-B-based alloy including Ga and the metal powder is used as the permanent magnet alloy material, an R-T-B-based magnet in which grain boundary phases include a first grain boundary phase, a second grain boundary phase, and a third grain boundary phase which have different total atomic concentrations of the rare earth elements, the third grain boundary phase has a lower total atomic concentration of the rare earth elements than the first grain boundary phase and the second grain boundary phase, and has a higher atomic concentration of Fe than the first grain boundary phase and the second grain boundary phase can be easily obtained by pressing and sintering the material.

In addition, in a case in which a material including the R-T-B-based alloy including Ga and the metal powder is used as the permanent magnet alloy material, the volume fraction of the third grain boundary phase in the sintered compact can be easily adjusted in a range of 0.005% to 0.25% by adjusting the use amount of the metal powder included in the permanent magnet alloy material, and an R-T-B-based magnet having a higher coercivity (Hcj) can be obtained.

Furthermore, the permanent magnet alloy material is preferably a mixture obtained by mixing powder consisting of the R-T-B-based alloy including Ga and the metal powder. In a case in which the permanent magnet alloy material is a mixture obtained by mixing powder consisting of the R-T-B-based alloy including Ga and the metal powder, it is possible to easily obtain a permanent magnet alloy material having uniform qualities simply by mixing the R-T-B-based alloy including Ga powder and the metal powder, and, also, it is possible to easily obtain the R-T-B-based magnet having uniform qualities by pressing and sintering the material.

In the R-T-B-based alloy including Ga which is included in the permanent magnet alloy material, R is one or two or more selected from Nd, Pr, Dy, and Tb, and Dy or Tb is preferably included in the R-T-B-based alloy at 4 mass % to 9.5 mass %.

The average particle size (d50) of the powder consisting of the R-T-B-based alloy is preferably 3 μm to 4.5 μm. In addition, the average particle size (d50) of the metal powder is preferably in a range of 0.01 μm to 300 μm.

In addition, examples of the metal powder included in the permanent magnet alloy material which can be used include powders of Al, Si, Ti, Ni, W, Zr, TiAl alloys, Cu, Mo, Co, Fe, and Ta, and are not particularly limited. The metal powder preferably includes any of Al, Si, Ti, Ni, W, Zr, TiAl alloys, Co, Fe, and Ta, and more preferably includes any of Fe, Ta, and W.

The permanent magnet alloy material preferably includes 0.002 mass % to 9 mass % of the metal powder, more preferably includes 0.02 mass % to 6 mass % of the metal powder, and still more preferably includes 0.6 mass % to 4 mass % of the metal powder. When the content of the metal powder is less than 0.002 mass %, there is a concern that the R-T-B-based magnet may not become an R-T-B-based magnet in which the grain boundary phases in the R-T-B-based magnet include the first grain boundary phase, the second grain boundary phase, and the third grain boundary phase which have different total atomic concentrations of the rare earth elements, the third grain boundary phase has a lower total atomic concentration of the rare earth elements than the first grain boundary phase and the second grain boundary phase and a higher atomic concentration of Fe than the first grain boundary phase and the second grain boundary phase such that it is not possible to sufficiently improve coercivity (HO of the R-T-B-based magnet. In addition, when the content of the metal powder exceeds 9 mass %, the magnetic characteristics such as remanence (Br) or maximum energy product (BHmax) of the R-T-B-based magnet become significantly degraded, which is not preferable.

The permanent magnet alloy material used when the R-T-B-based magnet of the invention is manufactured can be manufactured by mixing the R-T-B-based alloy including Ga and the metal powder, but is preferably a material manufactured using a method in which powder consisting of the R-T-B-based magnet including Ga and the metal powder are mixed.

The powder consisting of the R-T-B-based alloy including Ga is obtained using a method in which, for example, a molten alloy is cast using a strip casting (SC) method so as to manufacture a thin cast alloy piece, the obtained thin cast alloy piece is cracked using, for example, a hydrogen decrepitation method, and crushed using a crusher, or the like.

Examples of the hydrogen decrepitation method include a method in which a thin cast alloy piece is made to absorb hydrogen at room temperature, thermally treated at a temperature of approximately 300° C., then, depressurized so as to degas hydrogen, and then thermally treated at a temperature of approximately 500° C., thereby removing hydrogen in the thin cast alloy piece. Since the volume of the thin cast alloy piece which absorbs hydrogen in the hydrogen cracking method expands, a number of cracks are easily caused in the alloy, and the alloy is cracked.

In addition, examples of the method of crushing the hydrogen-decrepitated thin cast alloy piece include a method in which the hydrogen-cracked thin cast alloy piece is crushed into fine particles having an average particle size of 3 μm to 4.5 μm by a crusher such as a jet mill using high-pressure nitrogen of 0.6 MPa so as to produce powder, and the like.

Examples of a method of manufacturing an R-T-B-based magnet using the permanent magnet alloy material obtained in the above manner include a method in which a raw material having 0.02 mass % to 0.03 mass % of zinc stearate added as a lubricant to the permanent magnet alloy material is press-molded using a pressing machine or the like in a transverse magnetic field, sintered at 1030° C. to 1080° C. in a vacuum, and then thermally treated at 400° C. to 800° C.

In the above example, a case in which the R-T-B-based alloy including Ga is manufactured using the SC method has been described, but the R-T-B-based alloy including Ga which is used in the invention is not limited to an alloy manufactured using the SC method, and the R-T-B-based alloy including Ga may be manufactured using, for example, a centrifugal casting method, a book pressing method, or the like.

In addition, the R-T-B-based alloy including Ga and the metal powder may be mixed after powder consisting of the R-T-B-based alloy including Ga is obtained by crushing the thin cast alloy piece as described above; however, for example, before the thin cast alloy piece is crushed, a permanent magnet alloy material including the thin cast alloy piece may be crushed after the thin cast alloy piece and the metal powder are mixed so as to produce a permanent magnet alloy material. In this case, the R-T-B-based magnet is preferably manufactured by crushing the permanent magnet alloy material consisting of the thin cast alloy piece and the metal powder in the same manner as in the method of crushing the thin cast alloy piece so as to produce powder, then, pressing, and sintering the powder in the same manner as above.

In addition, the R-T-B-based alloy and the metal powder may be mixed after adding a lubricant such as zinc stearate to powder consisting of the R-T-B-based alloy.

The metal powder in the permanent magnet alloy material of the invention may be finely and uniformly dispersed. However, it may not need to be finely and uniformly dispersed. For example, the metal powder may have a particle size of 1 μm or more, and exhibits the effects even when aggregating at 5 μm or more. In addition, the effect of inclusion of the metal powder in the permanent magnet alloy material for improving coercivity becomes larger as the concentration of Dy increases, and is more significantly developed when Ga is included.

Since the grain boundary phases of the invention include the first grain boundary phase, the second grain boundary phase, and the third grain boundary phase which have different total atomic concentrations of the rare earth elements, the third grain boundary phase has a lower total atomic concentration of the rare earth elements than the first grain boundary phase and the second grain boundary phase, and has a higher atomic concentration of Fe than the first grain boundary phase and the second grain boundary phase, the R-T-B-based magnet of the embodiment has a high coercivity (Hcj), and, furthermore, becomes preferable as a magnet for motors which has sufficiently high remanence (Br).

Coercivity (Hcj) of the R-T-B-based magnet is preferably higher, and, in a case in which the R-T-B-based magnet is used as a magnet for motors, coercivity is preferably 30 kOe or more. When coercivity (Hcj) is lower than 30 kOe in the magnet for motors, there are cases in which the heat resistance is not sufficient for motors.

In addition, remanence (Br) of the R-T-B-based magnet is also preferably higher, and, in a case in which the R-T-B-based magnet is used as a magnet for motors, remanence is preferably 10.5 kG or more. When remanence (Br) of the R-T-B-based magnet is lower than 10.5 kG, there is a concern that the torque of a motor may be insufficient, and this R-T-B-based magnet is not preferable as a magnet for motors.

Since the R-T-B-based magnet of the embodiment can obtain a sufficiently high coercivity (Hcj) without increasing the concentration of Dy in the R-T-B-based alloy, and can suppress degradation of the magnetic characteristics such as remanence (Br) through a decrease in the added amount of Dy, the R-T-B-based magnet has excellent magnetic properties sufficient to be preferably used in motors, automobiles, power generators, wind power-generating apparatuses and the like.

### EXAMPLES

### Experimental Example 1

Nd metal (purity of 99 wt % or more), Pr metal (purity of 99 wt % or more), Dy metal (purity of 99 wt % or more), ferro-boron (Fe 80 wt %, B 20 wt %), Al metal (purity of 99 wt % or more), Co metal (purity of 99 wt % or more), Cu metal (purity of 99 wt % or more), Ga metal (purity of 99 wt % or more), and an iron ingot (purity of 99 wt % or more) were weighed so as to obtain the component compositions of Alloys A to D shown in Table 1, and charged into alumina crucibles.

TABLE 1

| | | Nd | Pr | Dy | B | Al | Ga | Co | Cu | Tb | Fe | C | O | N |
|---|---|---|---|---|---|---|---|---|---|---|---|---|---|---|
| Alloy A | wt % | 20.3 | 6.2 | 4.4 | 0.9 | 0.1 | 0.1 | 2.1 | 0.1 | 0.0 | 65.8 | 0.01 | 0.01 | 0.00 |
| | at % | 9.2 | 2.9 | 1.8 | 5.5 | 0.3 | 0.1 | 2.3 | 0.1 | 0.0 | 77.4 | 0.07 | 0.05 | 0.01 |
| Alloy B | wt % | 19.3 | 6.1 | 7.2 | 1.0 | 0.2 | 0.0 | 0.9 | 0.1 | 0.0 | 65.3 | 0.01 | 0.01 | 0.00 |
| | at % | 8.9 | 2.9 | 2.9 | 5.9 | 0.4 | 0.0 | 1.0 | 0.0 | 0.0 | 77.6 | 0.08 | 0.06 | 0.01 |
| Alloy C | wt % | 18.8 | 5.7 | 8.7 | 1.0 | 0.2 | 0.0 | 0.9 | 0.1 | 0.0 | 64.8 | 0.01 | 0.02 | 0.00 |
| | at % | 8.7 | 2.7 | 3.5 | 5.9 | 0.4 | 0.0 | 1.0 | 0.1 | 0.0 | 77.3 | 0.08 | 0.08 | 0.01 |
| Alloy D | wt % | 16.5 | 5.0 | 9.5 | 0.9 | 0.2 | 0.1 | 2.1 | 0.1 | 0.0 | 65.7 | 0.01 | 0.01 | 0.00 |
| | at % | 7.5 | 2.3 | 3.9 | 5.5 | 0.4 | 0.1 | 2.3 | 0.1 | 0.0 | 77.6 | 0.07 | 0.05 | 0.00 |

After that, the inside of a high-frequency vacuum induction furnace into which the aluminum crucibles were put was purged with Ar, heated to 1450° C. so as to melt the metals, the molten metals were poured into a water cooling copper roll, and thin cast alloy pieces were obtained by the scan casting (SC) method at a roll rotating rate of 1.0 m/sec so as to obtain an average thickness of approximately 0.3 mm.

Next, the thin cast alloy pieces were cracked using the hydrogen decrepitation method described below. Firstly, the thin cast alloy pieces were coarsely crushed to a diameter of approximately 5 mm, and were inserted into hydrogen at room temperature so as to allow absorption of hydrogen. Subsequently, a thermal treatment through which the coarsely-crushed and thin cast alloy pieces with absorbed hydrogen were heated to 300° C. was carried out. After that, the thin cast alloy pieces were depressurized so as to degas hydrogen, furthermore, a thermal treatment through which the thin cast alloy pieces were heated to 500° C. was carried out so as to discharge and remove hydrogen in the thin cast alloy pieces, and cooled to room temperature.

Next, 0.025 wt % of zinc stearate was added as a lubricant to the hydrogen-cracked thin cast alloy pieces, and the hydrogen-cracked thin cast alloy pieces were finely crushed to an average particle size (d50) of 4.5 μm using a jet mill (HOSOKAWA MICRON 100AFG) and high-pressure nitrogen of 0.6 MPa, thereby obtaining powder.

Metal powders having the particle sizes shown in Table 2 were added to and mixed with powders (Alloys A to D) which were obtained in the above manner and consisted of R-T-B-based alloys having the average particle sizes shown in Table 1 in the proportions (the concentrations (mass %) of the metal powders included in the permanent magnet alloy materials) shown in Table 3, thereby manufacturing permanent magnet alloy materials. The particle sizes of the metal powders were measured using a laser diffractometer.

TABLE 2

| Metal powder | Average particle size d50 (μm) |
|---|---|
| W | 6.5 |
| Ta | 11.5 |
| Fe | 6.2 |

TABLE 3

| | | | Added | | | | |
|---|---|---|---|---|---|---|---|
| Experimental | Alloy | Metal | amount | Hcj | Br | SR | BHₘₐₓ |
| example | name | powder | (wt %) | (kOe) | (kG) | (%) | (MGOe) |
| 1 | A | None | — | 22.5 | 13.1 | 94.7 | 41.5 |
| 2 | | Fe | 0.2 | 23.5 | 13.1 | 95.1 | 41.8 |
| 3 | | | 1.0 | 23.1 | 13.0 | 95.1 | 41.1 |
| 4 | | Ta | 0.0 | 23.2 | 13.1 | 94.7 | 41.4 |
| 5 | | | 0.1 | 23.4 | 13.2 | 95.1 | 42.1 |
| 6 | | | 0.2 | 23.4 | 13.1 | 95.0 | 41.5 |
| 7 | | | 0.6 | 23.7 | 13.0 | 94.9 | 40.7 |
| 8 | | | 1.8 | 24.0 | 12.8 | 94.4 | 39.7 |
| 9 | | | 4.0 | 24.4 | 11.8 | 87.5 | 30.1 |
| 10 | | W | 0.2 | 24.1 | 13.1 | 93.1 | 41.6 |
| 11 | | | 0.6 | 23.6 | 13.0 | 94.5 | 41.1 |
| 12 | B | None | — | 27.2 | 11.7 | 93.1 | 33.5 |
| 13 | | Fe | 0.1 | 27.7 | 11.8 | 92.6 | 33.6 |
| 14 | | | 0.2 | 20.9 | 8.8 | 93.9 | 25.3 |
| 15 | | Ta | 0.1 | 28.6 | 11.7 | 92.7 | 33.7 |
| 16 | | | 0.2 | 28.0 | 11.8 | 93.2 | 33.7 |
| 17 | | | 1.0 | 26.8 | 11.6 | 84.7 | 32.1 |
| 18 | | W | 0.1 | 28.9 | 11.9 | 90.4 | 34.7 |
| 19 | | | 0.0 | 27.5 | 11.7 | 92.8 | 33.7 |
| 20 | | | 0.2 | 28.0 | 11.6 | 90.6 | 32.8 |
| 21 | | | 2.0 | 27.9 | 11.7 | 92.2 | 33.2 |
| 22 | C | None | — | 29.9 | 11.6 | 93.6 | 32.6 |
| 23 | | Fe | 0.2 | 30.4 | 11.5 | 91.7 | 32.2 |
| 24 | | | 0.4 | 31.6 | 11.4 | 91.6 | 31.8 |
| 25 | | | 4.0 | 29.3 | 11.9 | 92.4 | 34.6 |
| 26 | | Ta | 0.1 | 28.6 | 11.7 | 92.7 | 33.7 |
| 27 | | | 0.2 | 29.6 | 11.4 | 90.9 | 31.7 |
| 28 | | | 1.0 | 30.7 | 11.4 | 91.6 | 32.1 |
| 29 | | W | 0.1 | 30.6 | 11.6 | 93.8 | 33.2 |
| 30 | | | 1.0 | 30.7 | 11.3 | 92.4 | 31.3 |
| 31 | D | None | — | 30.3 | 11.6 | 90.7 | 32.8 |
| 32 | | Fe | 0.2 | 30.6 | 11.5 | 89.1 | 32.2 |
| 33 | | | 1.0 | 34.1 | 11.6 | 90.9 | 33.0 |
| 34 | | | 2.0 | 34.1 | 11.7 | 90.5 | 33.8 |
| 35 | | Ta | 0.2 | 30.0 | 11.5 | 88.8 | 30.7 |
| 36 | | | 1.0 | 33.7 | 11.5 | 90.3 | 32.7 |
| 37 | | | 2.0 | 35.3 | 11.5 | 90.7 | 32.5 |
| 38 | | | 4.0 | 35.4 | 11.1 | 86.9 | 28.6 |
| 39 | | | 6.0 | 35.8 | 9.9 | 75.0 | 18.7 |
| 40 | | W | 0.2 | 30.0 | 11.4 | 89.1 | 31.5 |
| 41 | | | 1.0 | 35.8 | 11.5 | 88.6 | 32.7 |
| 42 | | | 2.0 | 35.7 | 11.4 | 87.2 | 31.8 |
| 43 | | | 3.0 | 35.9 | 11.2 | 87.1 | 30.7 |
| 44 | | | 5.0 | 34.1 | 10.9 | 84.1 | 28.2 |
| 45 | | | 6.0 | 33.8 | 10.6 | 81.4 | 26.0 |

Next, the permanent magnet alloy material obtained in the above manner was press-molded at a pressing pressure of 0.8 t/cm² in a transverse magnetic field using a pressing machine so as to produce green pellets. After that, the obtained green pellets were sintered in a vacuum. The sintering was carried out at a sintering temperature of 1080° C. After that, the green pellets were thermally treated at 500° C. and cooled, thereby manufacturing R-T-B-based magnets of Experimental examples 1 to 45.

The magnetic properties of the R-T-B-based magnets of Experimental examples 1 to 45 were measured using a BH curve tracer (Toei Kogyo TPM2-10). The results are shown in Table 3.

In Table 3, “Hcj” represents coercivity, “Br” represents remanence, “SR” represents the squareness, and “BHmax” represents the maximum energy product. In addition, the values of the magnetic characteristics are the average of the measured values of five R-T-B-based magnets of the respective alloy names.

In addition, the volume proportions of the third grain boundary phase of the R-rich phase of the R-T-B-based magnets of Experimental examples 1, 3, 8, 11, 31, 33, 34, 37, and 42 obtained in the above manner were investigated using a method described below.

That is, the R-T-B-based magnets having a thickness of ±10% or less of the average thickness were implanted in a resin, polished, backscattered electron images of the magnets were taken using a scanning electron microscope (JEOL JSM-5310), and the volume proportions of the third grain boundary phase of the R-rich phase were computed using the obtained 300 times-magnified photographs.

The results are shown in Table 4.

TABLE 4

| | | | | Volume |
|---|---|---|---|---|
| | | | | proportion |
| | | | | of third |
| Experimental | Alloy | | Added amount | grain boundary |
| example | name | Metal powder | (wt %) | phase (%) |
| 1 | A | Not added | 0.0 | 0.000 |
| 3 | | Fe | 1.0 | 0.005 |
| 8 | | Ta | 1.8 | 0.048 |
| 11 | | W | 0.6 | 0.020 |
| 31 | D | Not added | 0.0 | 0.000 |
| 33 | | Fe | 1.0 | 0.011 |
| 34 | | | 2.0 | 0.021 |
| 37 | | Ta | 2.0 | 0.088 |
| 42 | | W | 2.0 | 0.034 |

In addition, the backscattered electron images of the R-T-B-based magnets of Experimental examples 1 to 42 were taken at a magnification of 2000 times to 5000 times using a scanning electron microscope, the main phase and grain boundary phases (the first to third grain boundary phases) of the R-T-B-based magnets were identified using the contrast, and the compositions of the main phase and the grain boundary phases were investigated using an FE-SPMA (Electron Probe Micro Analyzer).

The results are shown in Tables 5 to 8.

TABLE 5
(At %)

| | Experimental | | | | | | | | | | | | | | |
|---|---|---|---|---|---|---|---|---|---|---|---|---|---|---|---|
| | example | Nd | Pr | Dy | Fe | B | Al | Co | Cu | Ga | Ta | W | C | O | R total |
| Main phase | 1 | 8.0 | 2.2 | 1.7 | 77.5 | 4.8 | 0.4 | 2.2 | 0.0 | | 0.0 | 0.0 | 0.4 | 2.8 | 11.9 |
| | 3 | 8.0 | 2.2 | 1.7 | 78.6 | 4.7 | 0.4 | 2.2 | 0.0 | | 0.0 | 0.0 | 0.2 | 1.9 | 11.9 |
| | 8 | 8.6 | 2.5 | 1.7 | 77.4 | 4.7 | 0.4 | 2.3 | 0.1 | | 0.1 | 0.0 | 0.2 | 2.1 | 12.8 |
| | 11 | 8.0 | 2.2 | 1.7 | 77.9 | 4.7 | 0.4 | 2.2 | 0.0 | | 0.0 | 0.1 | 0.7 | 2.2 | 11.9 |
| First grain | 1 | 42.8 | 19.2 | 0.4 | 7.6 | | 0.0 | 13.4 | 4.4 | 0.1 | | | 4.4 | 7.8 | 62.4 |
| boundary | 3 | 34.1 | 14.4 | 1.0 | 15.0 | | 0.1 | 9.1 | 3.5 | 0.2 | | | 6.0 | 16.6 | 49.6 |
| phase | 8 | 40.9 | 17.6 | 1.0 | 11.5 | | 0.1 | 10.5 | 3.2 | 0.2 | | | 3.9 | 11.1 | 59.5 |
| | 11 | 38.9 | 17.3 | 0.6 | 16.0 | | 0.2 | 12.0 | 3.8 | 0.3 | | | 4.0 | 6.8 | 56.8 |
| Second grain | 1 | 13.8 | 4.4 | 1.7 | 3.5 | | | | | | | | 7.5 | 69.1 | 20.0 |
| boundary | 3 | 24.3 | 7.4 | 3.0 | 3.1 | | | | | | | | 15.1 | 47.1 | 34.7 |
| phase | 8 | 23.6 | 7.3 | 2.8 | 3.3 | | | | | | | | 13.7 | 9.1 | 33.7 |
| | 11 | 23.1 | 7.2 | 2.8 | 3.7 | | | | | | | | 13.4 | 49.9 | 33.1 |
| Third grain | 3 | 21.2 | 7.7 | 1.1 | 53.8 | | 1.0 | 1.8 | 0.9 | 2.1 | | | 1.1 | 9.3 | 30.0 |
| boundary | 8 | 18.9 | 7.2 | 0.6 | 56.9 | | 1.9 | 1.5 | 2.5 | 2.5 | | | 1.0 | 8.9 | 26.7 |
| phase | 11 | 19.1 | 7.2 | 0.7 | 59.5 | | 0.6 | 1.5 | 0.3 | 2.1 | | | 1.0 | 8.0 | 26.9 |

TABLE 6
(At %)

| | Experimental | | | | | | | | | | | | | |
|---|---|---|---|---|---|---|---|---|---|---|---|---|---|---|
| | example | Nd | Pr | Dy | Fe | B | Al | Co | Cu | Ta | W | C | O | R total |
| Main phase | 12 | 6.9 | 2.0 | 2.7 | 77.9 | 4.9 | 0.5 | 1.0 | 0.0 | 0.0 | 0.0 | 1.1 | 2.9 | 11.6 |
| | 17 | 7.2 | 2.0 | 2.9 | 78.8 | 5.0 | 0.5 | 1.0 | 0.0 | 0.0 | 0.0 | 0.7 | 1.9 | 12.1 |
| First grain | 12 | 41.0 | 17.8 | 0.9 | 8.4 | | 0.1 | 11.7 | 5.2 | | | 5.3 | 9.6 | 59.7 |
| boundary phase | 17 | 42.1 | 18.6 | 0.6 | 8.4 | | 0.0 | 13.4 | 4.4 | | | 4.9 | 7.6 | 61.3 |
| Second grain | 12 | 20.2 | 6.3 | 5.3 | 2.5 | | | | | | | 13.2 | 52.4 | 31.8 |
| boundary phase | 17 | 24.4 | 7.6 | 6.2 | 3.5 | | | | | | | 16.9 | 41.5 | 38.2 |

TABLE 7
(At %)

| | Experimental | | | | | | | | | | | | | |
|---|---|---|---|---|---|---|---|---|---|---|---|---|---|---|
| | example | Nd | Pr | Dy | Fe | B | Al | Co | Cu | Ta | W | C | O | R total |
| Main phase | 22 | 6.6 | 1.7 | 3.5 | 78.8 | 5.1 | 0.5 | 1.0 | 0.0 | 0.0 | 0.0 | 0.1 | 2.8 | 11.7 |
| | 25 | 6.7 | 1.8 | 3.3 | 79.3 | 5.3 | 0.5 | 1.0 | 0.0 | 0.0 | 0.0 | 0.0 | 2.2 | 11.8 |
| | 28 | 6.7 | 1.8 | 3.4 | 78.9 | 5.0 | 0.5 | 1.0 | 0.0 | 0.0 | 0.0 | 0.6 | 2.1 | 11.9 |
| | 30 | 6.8 | 1.8 | 3.2 | 78.7 | 5.2 | 0.5 | 1.0 | 0.0 | 0.0 | 0.1 | 0.9 | 1.9 | 11.7 |
| First grain | 22 | 40.7 | 17.0 | 0.8 | 8.7 | | 0.1 | 12.4 | 4.8 | | | 4.7 | 10.9 | 58.5 |
| boundary | 25 | 43.0 | 18.4 | 0.8 | 8.0 | | 0.0 | 12.6 | 5.3 | | | 3.9 | 7.9 | 62.2 |
| phase | 28 | 42.7 | 18.5 | 0.7 | 8.1 | | 0.1 | 13.3 | 4.5 | | | 5.5 | 6.7 | 61.8 |
| | 30 | 42.8 | 17.9 | 0.6 | 7.6 | | 0.1 | 13.2 | 4.7 | | | 4.9 | 8.2 | 61.4 |
| Second grain | 22 | 19.4 | 5.4 | 7.2 | 2.9 | | | | | | | 12.5 | 52.6 | 32.0 |
| boundary | 25 | 19.5 | 5.8 | 6.5 | 3.6 | | | | | | | 12.9 | 51.6 | 31.9 |
| phase | 28 | 22.3 | 6.0 | 8.2 | 4.3 | | | | | | | 13.6 | 46.5 | 36.5 |
| | 30 | 19.7 | 5.0 | 8.0 | 3.3 | | | | | | | 12.9 | 51.0 | 32.8 |

TABLE 8
(At %)

| | Experimental | | | | | | | | | | | | | | |
|---|---|---|---|---|---|---|---|---|---|---|---|---|---|---|---|
| | example | Nd | Pr | Dy | Fe | B | Al | Co | Cu | Ga | Ta | W | C | O | R total |
| Main phase | 31 | 6.5 | 1.8 | 3.5 | 77.4 | 4.7 | 0.4 | 2.2 | 0.0 | | 0.0 | 0.0 | 0.3 | 3.3 | 11.7 |
| | 34 | 6.5 | 1.7 | 3.5 | 77.2 | 4.4 | 0.4 | 2.2 | 0.0 | | 0.0 | 0.0 | 0.2 | 4.0 | 11.7 |
| | 37 | 6.5 | 1.8 | 3.5 | 77.7 | 5.0 | 0.4 | 0.0 | 2.2 | | 0.1 | 0.0 | 0.8 | 2.1 | 11.7 |
| | 42 | 6.4 | 1.7 | 3.6 | 76.9 | 5.0 | 0.4 | 2.2 | 0.0 | | 0.0 | 0.1 | 1.4 | 2.5 | 11.6 |
| First grain | 31 | 42.1 | 18.4 | 0.9 | 9.7 | | 0.0 | 13.2 | 4.8 | 0.0 | | | 4.5 | 6.4 | 61.4 |
| boundary | 34 | 36.0 | 16.4 | 1.3 | 14.7 | | 0.1 | 9.8 | 4.5 | 0.3 | | | 4.3 | 12.6 | 53.8 |
| phase | 37 | 32.4 | 13.3 | 2.3 | 29.1 | | 0.5 | 9.4 | 3.5 | 0.8 | | | 4.1 | 4.6 | 48.0 |
| | 42 | 38.5 | 16.6 | 1.5 | 12.8 | | 0.1 | 13.3 | 3.5 | 0.1 | | | 7.9 | 5.8 | 56.5 |
| Second grain | 31 | 19.6 | 5.6 | 8.8 | 3.4 | | | | | | | | 14.6 | 48.0 | 34.0 |
| boundary | 34 | 19.2 | 5.6 | 7.4 | 4.1 | | | | | | | | 13.4 | 50.2 | 32.3 |
| phase | 37 | 21.4 | 6.4 | 8.1 | 5.0 | | | | | | | | 14.2 | 44.9 | 35.8 |
| | 42 | 20.1 | 5.8 | 8.2 | 5.4 | | | | | | | | 16.2 | 44.3 | 34.1 |
| Third grain | 34 | 16.8 | 6.0 | 2.0 | 59.5 | | 0.7 | 0.5 | 1.6 | 2.0 | | | 1.5 | 9.6 | 24.8 |
| boundary | 37 | 14.9 | 5.2 | 3.2 | 63.4 | | 0.5 | 1.6 | 0.1 | 1.2 | | | 2.3 | 7.6 | 23.3 |
| phase | 42 | 18.5 | 6.7 | 1.9 | 57.8 | | 1.1 | 1.4 | 0.3 | 2.1 | | | 2.1 | 8.1 | 27.1 |

Among Experimental examples 1 to 45, in Experimental examples 1 and 31 in which the permanent magnet alloy material did not include the metal powder and Experimental examples 12 to 30 which were R-T-B-based magnets including no Ga, the third grain boundary phase was rarely observed, and the volume proportion of the third grain boundary phase was less than 0.005%.

In more detail, in Experimental examples 1, 31, and 12 to 30, most of the grain boundary phases consisted of the first grain boundary phase and the second grain boundary phase. In addition, Experimental examples 12 and 22 included a third phase having a higher atomic concentration of Fe than the first grain boundary phase and the second grain boundary phase, but the third phase was neither a grain boundary phase including more R than the main phase nor the third grain boundary phase.

As shown in Tables 3, 5 to 8, in Experimental examples 2 to 11 which were examples of the invention in which the grain boundary phases including more R than the main phase include the first grain boundary phase, the second grain boundary phase, and the third grain boundary phase which have different total atomic concentrations of the rare earth elements, the third grain boundary phase has a lower total atomic concentration of the rare earth elements than the first grain boundary phase and the second grain boundary phase, and has a higher atomic concentration of Fe than the first grain boundary phase and the second grain boundary phase, coercivity (Hcj) increased compared to Experimental example 1 including no third grain boundary phase. In addition, in the R-T-B-based magnets of Experimental examples 32 to 34, 36 to 39, and 41 to 45 which were examples of the invention, coercivity (Hcj) increased compared to Experimental example 31 including no third grain boundary phase.

It is found from the above fact that, when the grain boundary phases include the first grain boundary phase, the second grain boundary phase, and the third grain boundary phase, it is possible to increase coercivity without increasing the added amount of Dy.

In addition, as shown in Tables 3 and 4, it could be confirmed that, in a case in which the volume proportion of the third grain boundary phase in a sintered compact is 0.005% to 0.25%, it is possible to effectively improve coercivity (Hcj).

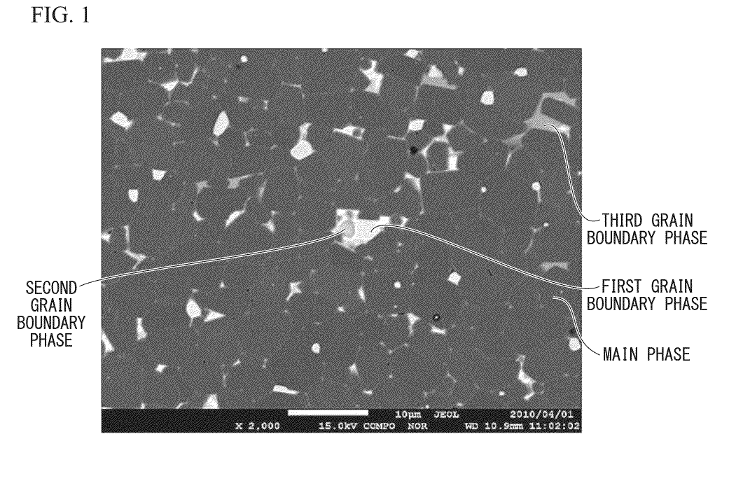

In addition, FIG. 1 is a microscope photograph of the R-T-B-based magnet of Experimental example 3 which is an example of the R-T-B-based rare earth permanent magnet of the invention. In the microscope photograph (backscattered electron image of an FE-EPMA) of the R-T-B-based magnet shown in FIG. 1, the dark gray portions which appear almost black are the main phase, and the light gray portions are the grain boundary phases. It is found that, in the R-T-B-based magnet shown in FIG. 1, the grain boundary phases include the first grain boundary phase (the whitish gray portions in the light gray portions in FIG. 1), the second grain boundary phase (the blackish portions in the light gray portions in FIG. 1), and the third grain boundary phase (the more blackish portions in the light gray portions in FIG. 1) which have different average atomic weights.

The backscattered electron images were taken at a magnification of 2000 times and an acceleration voltage of 15 kV.

### INDUSTRIAL APPLICABILITY

The R-T-B-based rare earth magnet of the invention has excellent magnetic characteristics which can be preferably used for motors or power generators, and therefore the invention is extremely useful industrially.

1. An R-T-B-based rare earth permanent magnet comprising:
a sintered compact having a main phase mainly including R₂Fe₁₄B and grain boundary phases including more R than the main phase,
wherein R refers to rare earth elements including Nd as an essential element, the sintered compact includes Ga as an essential element,
the grain boundary phases include a first grain boundary phase, a second grain boundary phase, and a third grain boundary phase which have different total atomic concentrations of rare earth elements, and
the third grain boundary phase has a lower total atomic concentration of the rare earth elements than the first grain boundary phase and the second grain boundary phase, and has a higher atomic concentration of Fe than the first grain boundary phase and the second grain boundary phase.

2. The R-T-B-based rare earth permanent magnet according to claim 1, wherein an atomic concentration of Fe in the third grain boundary phase is 50 at % to 70 at %.

3. The R-T-B-based rare earth permanent magnet according to claim 1, wherein a volume proportion of the third grain boundary phase in the sintered compact is 0.005% to 0.25%.

4. The R-T-B-based rare earth permanent magnet according to claim 1, wherein an atomic concentration of Ga in the third grain boundary phase is higher than atomic concentrations of Ga in the first grain boundary phase and the second grain boundary phase.

5. The R-T-B-based rare earth permanent magnet according to claim 1, wherein the atomic concentration of Fe in the first grain boundary phase is higher than the atomic concentration of Fe in the second grain boundary phase.

6. The R-T-B-based rare earth permanent magnet according to claim 5, wherein a total atomic concentration of the rare earth elements in the first grain boundary phase is higher than a total atomic concentration of the rare earth elements in the second grain boundary phase.

7. The R-T-B-based rare earth permanent magnet according to claim 5, wherein the atomic concentration of oxygen in the second grain boundary phase is higher than the atomic concentrations of oxygen in the main phase, the first grain boundary phase or the third grain boundary phase.

8. A motor having the R-T-B-based rare earth permanent magnet according to claim 1.

9. An automobile having the motor according to claim 8.

10. A power generator having the R-T-B-based rare earth permanent magnet according to claim 1.

11. A wind power-generating apparatus having the power generator according to claim 10.
